(19) United States
(12) Patent Application Publication
(10) Pub. No.: US 2013/0006693 A1
(43) Pub. Date: Jan. 3, 2013

(54) Planning a Meeting or Event

(76) Inventors: James M. Haynes, III, San Francisco, CA (US); Anthony W. Ulwick, Mill Valley, CA (US)

(21) Appl. No.: 13/539,272

(22) Filed: Jun. 29, 2012

Related U.S. Application Data
(60) Provisional application No. 61/502,539, filed on Jun. 29, 2011.

(51) Int. Cl. G06Q 10/06

(52) U.S. Cl. 705/7.23

(57) ABSTRACT

A technique for assisting one or more individuals in planning a meeting or event using metrics. It has been determined that a core job of planning a meeting or event can entail 15 different steps (with possibly 5 additional sub-steps) and have 141 different outcomes. The outcomes enable the job executors (which, in this paper, are the persons executing the job of planning the meeting or event, also referred to herein as the “planners”) to judge if the meeting or event has been adequately planned and executed. The techniques described in this paper enable a system and method to satisfy the outcomes (customer needs) for the job of planning a meeting or event.

### CROSS-REFERENCE TO RELATED APPLICATIONS

This application claims priority to U.S. provisional Ser. No. 61/502,539 filed Jun. 29, 2011, entitled “Planning a Meeting or Event,” which is incorporated by reference.

### BACKGROUND

More often than not, planning is an essential part of arranging and/or hosting successful events or meetings, regardless of their size, attendance, agenda, or purpose (e.g., business or non-business related). Planning a meeting or event can also be functionally complex and involve a number of steps that need to be accomplished by one or more individuals responsible for planning the meeting or event (hereafter, also referred to as the “planners”). Depending on the type of event or meeting to be held, planning the event or meeting may involve one or more conference planners, meeting organizers, business meeting organizers, social event planners or coordinators, or wedding planners.

### SUMMARY

A technique for assisting one or more individuals in planning a meeting or event using metrics. It has been determined that a core job of planning a meeting or event can entail 15 different steps (with possibly 5 additional sub-steps) and have 141 different outcomes. The outcomes enable the job executors (which, in this paper, are the persons executing the job of planning the meeting or event, also referred to herein as the “planners”) to judge if the meeting or event has been adequately planned and executed. The techniques described in this paper enable a system and method to satisfy the outcomes (customer needs) for the job of planning a meeting or event.

### BRIEF DESCRIPTION OF THE DRAWINGS

FIG. 1 depicts a diagram of an example of a system for planning a meeting or event.

FIG. 2 depicts a flowchart of an example of a job map for planning a meeting or event.

FIG. 3 depicts a diagram of an example of an event planning platform.

FIG. 4 depicts a diagram of an example of a system for planning a meeting or event.

FIG. 5 depicts a flowchart of an example of a method for planning a meeting or event at an event planning platform.

### DETAILED DESCRIPTION

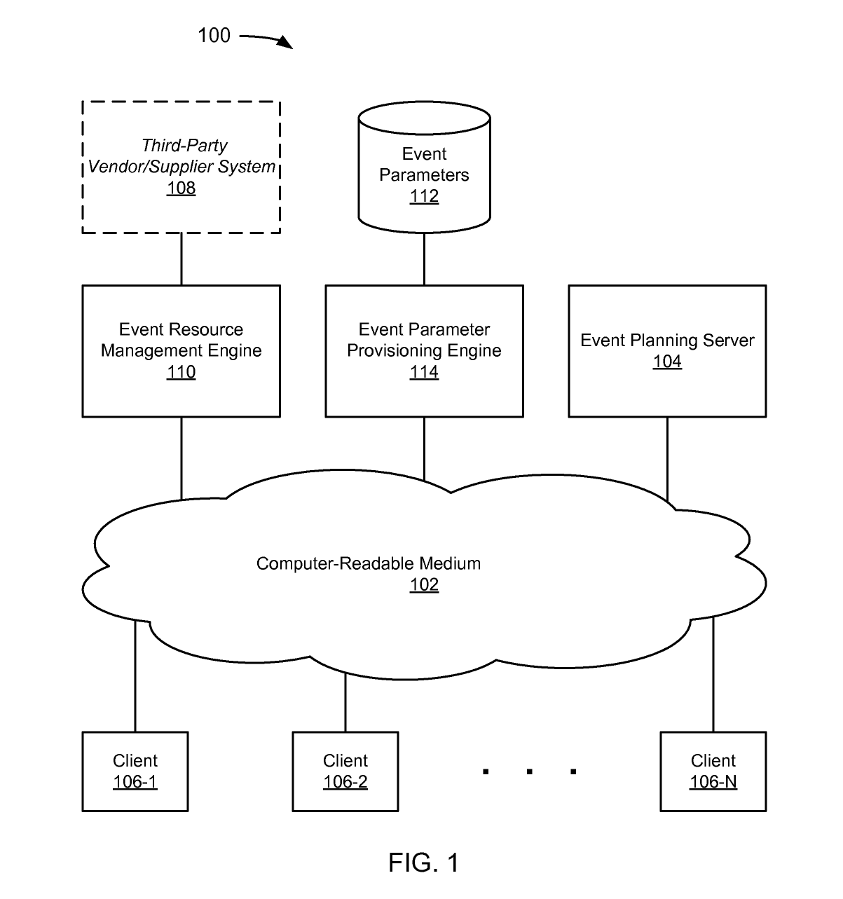

FIG. 1 depicts a diagram 100 of an example of a system for planning a meeting or an event (hereafter, also referred to as “event planning”). In the example of FIG. 1, the diagram 100 includes a computer-readable medium 102, a event planning server 104, clients 106-1 to 106-N (collectively, clients 106), a third-party vendor/supplier system 108, an event resource management engine 110, an event parameter datastore 112, and an event parameter provisioning engine 114.

In the example of FIG. 1, the computer-readable medium 102 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 102 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 102 can include a data path, such as a bus, in a computer. In such an implementation, one or more of the components illustrated in the example of FIG. 1 can be implemented on the same machine.

Referring once again to the example of FIG. 1, in the example of FIG. 1, the event planning server 104 is coupled to the computer-readable medium 102. The event planning server 104 can be implemented on a known or convenient computer system. The event planning server 104 is intended to illustrate one server that has the novel functionality, but there could be practically any number of servers coupled to the computer-readable medium 102 that meet this criterion. Moreover, partial functionality might be provided by a first server and partial functionality might be provided by a second server, where together the first and second servers provide the full functionality.

Functionality of the event planning server 104 can be carried out by one or more engines. As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor.

In the example of FIG. 1, the clients 106 are coupled to the computer-readable medium 102. The clients 106 can be implemented on one or more known or convenient computer systems. As used in this example, the clients 106 are clients of the event planning server 104. (The various components of the example of FIG. 1 can have other client-server relationships, as well.) In a specific implementation, the clients can both receive information about complex information from the event planning server 104 and provide inputs to the event planning server 104.

The third-party vendor/supplier system 108 is intended to represent a system operated by a vendor or supplier of one or more resources, such as facilities/venues, accommodations (e.g., for speakers, participants, or attendees of the meeting or event), day-of-event staff, speakers, participants, equipment rentals, materials suppliers, and the like, which are used in planning and/or executing a meeting or event (also referred to herein as “event resources”). The third-party vendor/supplier system 108 is generally configured to provide various systems and methods described herein with information regarding the various resources that vendor or supplier is providing the planner for the meeting or event. With respect to a given meeting or event, the information provided the third-party vendor/supplier system 108 can include, for example, the availability of resources, the status or condition of available resources, the status or condition of resources already secured for the given meeting or event, delivery time and date for resources already secured for the given meeting or event, and the like. The third-party vendor/supplier system 108 can further permit various systems and methods described herein to place and/or change orders for resources provided by the vendor or supplier.

In the example of FIG. 1, the third-party vendor/supplier system 108 is coupled to the computer-readable medium 102 by the event resource management engine 110. Through the event resource management 110 and its coupling to the third-party vendor/supplier system 108, the event planning server 104 can employ use of the resource information and/or resource order functionality offered by the third-party vendor/supplier system 108.

Conceptually, the third-party vendor/supplier system 108 is treated as the engine responsible for reporting conditions of event resources to the event planning server 104. Event resources reported on by the third-party vendor/supplier system 108 can those that are available from a vendor or supplier for use with a given meeting or event, and those already secured in connection with an event being planned or managed through the event planning server 104.

The event resource management 110 can further manage and monitor resources provided by various vendors and suppliers in connection with planning and/or executing meetings and events using the event planning server. For example, upon receiving an update from a vendor or supplier regarding a resource that can be used or will be used (i.e., already secured) in connection with an event, the event resource management 110 can inform the event planning server 104 of the update. Additionally, event resource management 110 can provide a meeting or event planner with access to at or near-real time information regarding resources provided by vendors and suppliers, and resource orders already placed (e.g., through the event planning server 104).

In the example of FIG. 1, the event parameters datastore 112 is coupled to the computer-readable medium 102 by the event parameter provisioning engine 114. The event parameters datastore 112 can store, in association with a given event or meeting being planned and/or managed by the event planning server 104, information regarding the meeting or event to be planned and held. Information stored on the event parameters datastore 112, in association with a given event or meeting being planned and/or managed, can include information regarding job executors/planners, location, resources (e.g., facilities, accommodations, speakers, participants, day-of-event staff, etc.), budgets, attendee registration, stakeholders, and vendors/suppliers. Additionally, the information regarding event resources can be for those resources needed for the given event or meeting, or for those resources that have already been allocated for the event/meeting.

The event parameters datastore 112, and other datastores described in this paper, can be implemented, for example, as software embodied in a physical computer-readable medium on a general- or specific-purpose machine, in firmware, in hardware, in a combination thereof, or in any applicable known or convenient device or system. This and other repositories described in this paper are intended, if applicable, to include any organization of data, including tables, comma-separated values (CSV) files, traditional databases (e.g., SQL), or other known or convenient organizational formats.

In an example of a system where the event parameters datastore 112 is implemented as a database, a database management system (DBMS) can be used to manage the event parameters datastore 112. In such a case, the DBMS may be thought of as part of the event parameters datastore 112 or as part of the event parameter provisioning engine 114, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

In the example of FIG. 1, the event parameter provisioning engine 114 acts as a data server for the event parameters datastore 112. Typically, the term “server” is reserved for situations where the engine has a client-server relationship with some other component. In an implementation where, e.g., the event parameters 112 and the event planning server 104 are local to one another, the event parameter provisioning engine 114 could be considered “part of” the event planning server 104, or in a database implementation, a database interface.

In the example of FIG. 1, the event parameter provisioning engine 114 can include data from any applicable sources, including event requirements datastores (such as documents), data feeds (e.g., from vendor/suppliers or feedback from registered attendees), schedules, resource orders for the event, execution plans for the event, event schedule(s) for the event, agenda(s) for the event, manual input, or the like. The platform can include an application programming interface (API) to facilitate integration of the system with various sources of data (and for outputs, as well). Thus, the event parameters datastore 112 can represent any applicable source of event data available from a source other than just the third-party vendor/supplier system 108 or data sources maintained by planners/job executors (e.g., a planner/job executor's individual calendar).

Advantageously, the platform is designed to satisfy underserved customer needs in the job of planning and managing meetings or events. From the customer's perspective, better satisfying customer needs is how the platform helps them get the job done better. For example, the platform can synchronize with a calendar to generate schedules for the event (e.g., vendor/supplier delivery schedule), event set-up schedule, generate event agendas, identify any scheduling issues regarding the schedules and agendas (e.g., from information provided by the third-party vendor/supplier system 108), and resolve and/or notify a planner/job executor regarding identified scheduling issues. For example, if the condition/status of an event resource allocated/secured for a planned event changes (e.g., according to information provided by the third-party vendor/supplier system 108), the platform can modify various schedules (e.g., delivery, event set-up, agenda, etc.) and notify the planner/job executor regarding the new schedule. The features of the platform can help customers achieve one or more of the 141 potential outcomes for the 14 job steps of a job map for planning a meeting or event.

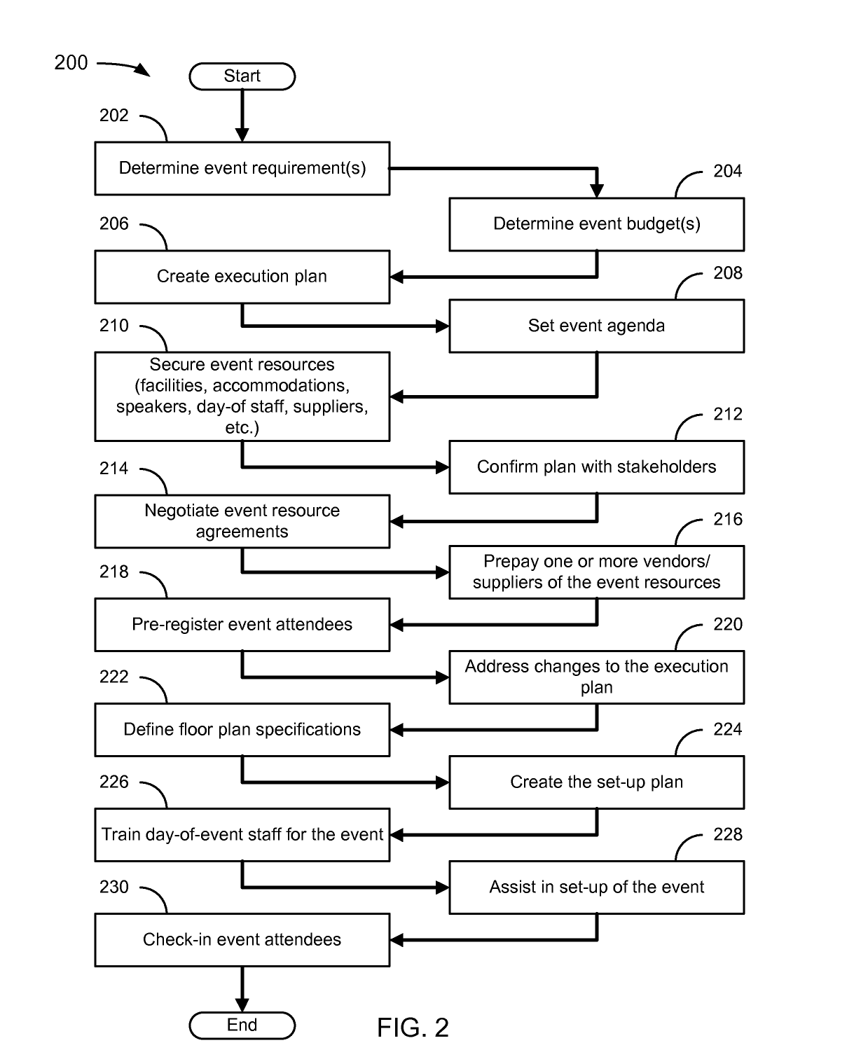

FIG. 2 depicts a flowchart 200 of an example of a job map for planning a meeting or an event. In the example of FIG. 2, the flowchart 200 starts at module 202 where the requirement(s) for a meeting or event to be planned/managed (“event requirement(s)”) are determined. The event requirements can originate from various data sources (e.g., documents, event parameters datastore) and/or be manually inputted by from a planner/job executor or stakeholder associated with the meeting or event to be planned/managed. Event requirements can include, for example, attendance expectations, venue requirements, staffing requirements, speaker requirements, the purpose/objective of a meeting or event, and the like. The requirements need not be from an “official” source if other data is deemed to be more useful.

In the example of FIG. 2, the flowchart 200 continues to module 204 where the budget(s) for the meeting or event (“event budget(s)”) are determined. The event budgets can originate from various data sources (e.g., documents, event parameters datastore) and/or be manually inputted by a planner/job executor or stakeholder associated with the meeting or event to be planned/managed. The even budget(s) determined for the meeting or event can comprise a single, total budget for the meeting/event, or can be a budget divided into several different budgets associated with different categories/aspects related to the meeting or event (e.g., entertainment, food, decorations, equipment rental or purchase, staffing, facility rental, etc.).

In the example of FIG. 2, the flowchart 200 continues to module 206 where an execution plan (“event execution plan” or “event plant”) is created for the meeting or event. In some implementations, the execution plan for the meeting or event provides a general overview for the meeting or event being planned or managed, and can be created in view of the event requirements determined by module 202 and/or event budget determined by the module 204.

In the example of FIG. 2, the flowchart 200 continues to module 208 where the agenda for the meeting or event (“event agenda”) is set or defined. Depending on the implementation, the agenda can be set or defined automatically based on the execution plan created by module 206 and/or manually by an agenda submitted by a planner/job executor or stakeholder associated with the meeting or event.

In the example of FIG. 2, the flowchart 200 continues to module 210 where resources for the event (“event resources”) are secured for the meeting or event. As noted herein, examples of even resources can include facilities/venues, accommodations (e.g., for speakers or attendees of the meeting or event), day-of-event staff, speakers, equipment rentals, materials suppliers, and the like. For some implementations, the event resources can be automatically secured through an interface with a third-party vendor/supplier system configured to receive orders for such resources. The event resources secured can be according to one or more of the event execution plan, the event agenda, the event budget(s) (e.g., event planning-phase budget), and the event requirement(s).

In the example of FIG. 2, the flowchart 200 continues to module 212 where a stakeholder associated with the meeting or even confirms the event execution plan. The confirmation of the plan can, for some implementations, be through a client-side interface (e.g., web-based interface) configured to present the execution plan (or a summary of the same) to the stakeholder for review and confirmation.

In the example of FIG. 2, the flowchart 200 continues to module 214 where agreements for the event resources are negotiated. The event resources negotiation process can be an automatic process where an event planning server negotiates the event resource agreement according to the event requirements, event budget, event execution plan, or some combination thereof.

In the example of FIG. 2, the flowchart 200 continues to module 216 where a vendor or supplier (“event vendor/supplier”) is prepaid for an event resource they are expected to provide for the meeting or event. The advance payment can be according to the event resource agreement negotiated at module 214. Additionally, the prepayment to the vendor can be performed after one or more conditions of the event requirements are satisfied and/or as the event budget permits. Implementations can facilitate the vendor/supplier prepayment by way of an interface with the third-party vendor/supplier system (e.g., through which authorize the vendor/supplier to submit a charge to banking institution) and/or by way of an interface of a banking institution (e.g., through which payment to the vendor/supplier is authorized).

In the example of FIG. 2, the flowchart 200 continues to module 218 where pre-registration to the meeting or event (“event pre-registration”) by attendees is enabled. The pre-registration, once enable, can be facilitated through any of various end-user client devices, typically though an online (e.g., Internet-based) user interface. In some implementations, the pre-registration feature can be closed when the number of pre-registrations has reached a certain number (e.g., based on venue capacity) and/or when a particular date has passed. Additionally, closure of pre-registration may be based on dynamic conditions, such as changes to the event resources available (e.g., availability of accommodations for attendees).

In the example of FIG. 2, the flowchart 200 continues to module 220 where changes to the event execution plan are addressed. For some implementations, addressing changes can be an automatic process performed by the system, or be a manual process performed by a planner/job executor once the system prompts the planner/job executor regarding the change. Changes to the execution plan can, for example result in a change notification being issued to planners/job executors, vendors/suppliers, speakers, and/or attendees of the meeting or event.

In the example of FIG. 2, the flowchart 200 continues to module 222 where a floor plan specification for the meeting or event is defined. In some implementations, the floor plan specification can be automatically defined by the system based on a virtual layout of the venue and/or the event resources (e.g., equipment and supplies) that will be deployed at the event. The virtual layout can be according to information received from venue operator via, for instance, an interface to a third-party vendor/supplier system.

In the example of FIG. 2, the flowchart 200 continues to module 224 where a set-up plan for the meeting or event is created. The set-up plan can, for some implementations, be created according to the event execution plan created by module 206, and/or the floor plan specific defined by module 222. The set-up plan can be further created according to information received from venue operator via, for instance, an interface to a third-party vendor/supplier system.

In the example of FIG. 2, the flowchart 200 continues to module 226 where the day-of-event staff are trained. The training process can be according to the event execution plan, the event requirements, and according to event budgets. Additionally, for some implementations, the system can produce instructions and/or documentation drafted to train the day-of-event staff.

In the example of FIG. 2, the flowchart 200 continues to module 228 where the set-up of the event is performed. Generally, the set-up of the event is performed according to the set-up plan generated at module 224.

In the example of FIG. 2, the flowchart 200 ends at module 230 where attendees are checked-in to the meeting or event. The check-in process, once started, may be facilitated through an online-based interface accessible over computing devices on an open or closed computer network.

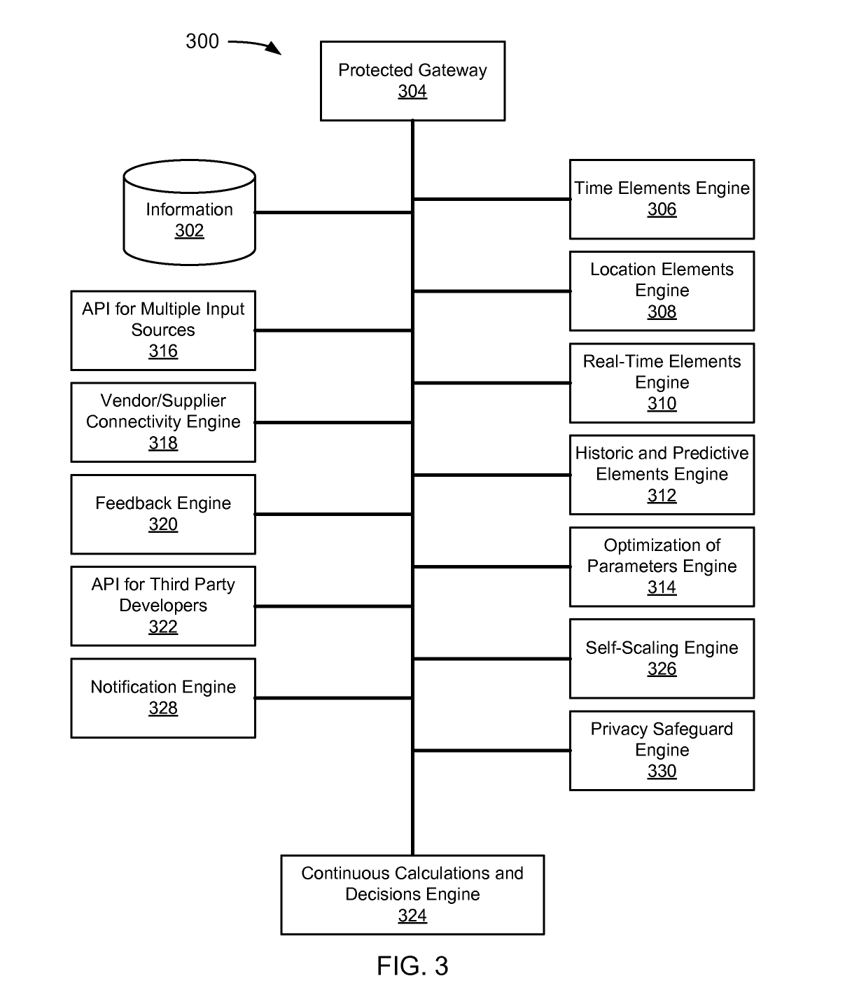

FIG. 3 depicts a diagram 300 of an example of an event planning platform. The platform is intended to help a person (planner/job executor) plan and/or manage a meeting or event with minimal or no input or decision-making by the person. In a specific implementation, the platform obtains relatively large amounts of data and information that impacts planning a meeting or event and informs the planner/job executor of recommended actions. Additionally, in particular implementations, the decision-making functions can take place in Internet-based resources, such as a cloud-based service. Solution features can be integrated into the platform and delivered to the user through one or more devices and/or applications. In the example of FIG. 3, the diagram 300 includes an information datastore 302, a protected gateway 304, a time elements engine 306, a location elements engine 308, a real-time elements engine 310, a historic and predictive elements engine 312, an optimization of parameters engine 314, an API for multiple input sources 316, a vendor/supplier connectivity engine 318, a feedback engine 320, an API for third party developers 322, a continuous calculations and decisions engine 324, a self-scaling engine 326, a notification engine 328, and a privacy safeguard engine 330.

In the example of FIG. 3, the information datastore 302 incorporates information from multiple datastores such an event parameters datastore and datastores containing information relating to event facilities, hotels, vendors, speakers, participants, calendars, contracts, and the like. The information datastore 302 thus includes any information useful in planning or managing a meeting or event.

In the example of FIG. 3, the protected gateway 304 ensures the platform does not become a “hacker's pathway” to event related systems, such as registration systems, third-party vendor/supplier systems, or event resource related systems. Known or convenient security techniques can be employed to ensure system security.

In the example of FIG. 3, the time elements engine 306 ensures the platform knows what time it is and can create accurate calendar and schedules in association with the meetings or events.

In the example of FIG. 3, the location elements engine 308 can identify location elements associated with a planned/managed meeting or event, such as the location of the planner/job executor, the location of the meeting or event, the location of vendors/suppliers of event resources, location of event resources, and location of attendees. In some implementations, it can be desirable to determine the relative location of meeting/event elements with respect to one another (e.g., location of speaker/attendee accommodations relative to the meeting/event venue for transportation purposes).

In the example of FIG. 3, the real time elements engine 310 delivers real-time information to planners/job executors, such as a change in the availability of event resources (e.g., supplies). In specific implementations, the platform can incorporate up-to-date data as rapidly as the data becomes available.

In the example of FIG. 3, the historic and predictive elements engine 312 can combine historic logs with a prediction engine. In a specific implementation, the platform can modify event parameters based upon historic data (e.g., historical data relating to vendor/supplier dependability), and can determine the likelihood of whether a particular vendor/supplier will provide their respective event resources (e.g., supplies or rental equipment) in a timely manner.

In the example of FIG. 3, the optimization of parameters engine 314 can optimize event parameters to optimally plan and/or manage a meeting or event. In a specific implementation, the platform has a robust algorithm implemented in order to allow the platform to make a decision. A goal is to minimize the need for a customer to think about how to best plan a meeting or event. The result is a platform that does not need any user input regarding maintenance (though some input may or may not be desirable in certain instances). For example, the optimization of parameters engine 314 can automatically calculate when supplies will be delivered or whether supplies will be deliver on time by a particular vendor/supplier.

In the example of FIG. 3, the API for multiple input sources 316 enables the platform to communicate with a variety of different sources of or destinations for data. This can be useful for receiving data from sensors, data feeds, and manual inputs, and for providing instructions to sensors or output to display devices. The API for multiple input sources 316 can include a number of different APIs that are referred to collectively as the API for multiple input sources. For example, APIs can be utilized to access multiple types of calendars, such Google® Calendar, Microsoft® Outlook®, and Lotus Notes®.

In the example of FIG. 3, the vendor/supplier connectivity engine 318 includes a communication link between a third-party vendor/supplier system and the platform. In a specific implementation, the vendor/supplier connectivity engine 318 can use equipment systems and APIs to connect to the platform.

In the example of FIG. 3, the feedback engine 320 includes a feedback channel for improving decision-making capabilities. In a specific implementation, the platform learns over time and becomes more accurate in order to understand an event planner's preferences. For example, the feedback engine 320 can be configured to infer destination based factors such as size and location of event, types of suppliers used in the past, and more from the feedback channel.

In the example of FIG. 3, the API for third party developers 322 makes it easier for third party developers to create applications on the platform. The API for third party developers 322 can include a number of different APIs that are referred to collectively as the API for third party developers.

In the example of FIG. 3, the continuous calculations and decisions engine 324 enables the platform to continuously deliver information. Continuous calculations and decisions can be accomplished by using a server that is not taken off-line to the extent that is possible. Moreover, a breakdown in communications links does not necessarily mean the platform ceases to perform calculations and make decisions. In a specific implementation, the continuous calculations and decisions engine 324 can operate without wireless connectivity. For example, the platform can cache data in case of a lapse in cellular or other wireless coverage and, if connectivity is lost, the system does not “go blank” and will have the latest information as of when connectivity was lost (and perhaps updated through other channels while connectivity is down). In doing so, the continuous calculations and decisions engine 324 can continuously deliver information (e.g., information from vendors/suppliers) to the system as it's used to plan and manage a meeting or event.

In the example of FIG. 3, the self-scaling engine 326 ensures no additional end-user hardware is required. In a specific implementation, the platform can detect resources available and scale service to the available resource. Thus, minimally essential capability should be available on user owned device, regardless of the capabilities of the device beyond a certain constant threshold. As more resources become available, service scales upward. In a specific implementation, the platform can work on a variety of popular devices, such as web-enabled devices, PCs, tablets, smartphones, etc.

In the example of FIG. 3, the notification engine 328 can provide notifications to users. Devices with the capability can receive SMS notifications or other types of messages depending upon the capabilities of the device and implementation- and/or configuration-specific capabilities of the platform. The platform provides end user alerts, for example, to alert a planner/job executor or meeting/event attendee of an updated event schedule by SMS.

In the example of FIG. 3, the privacy safeguard engine 330 provides privacy safeguards that are determined to be appropriate generally or for a given implementation. The platform can minimize privacy barriers to adoption and use of the system. In a specific implementation, individually identifiable information is not retained at any central server sites longer than necessary. Alternatively or in addition, individual historical data is retained only on user-controlled devices.

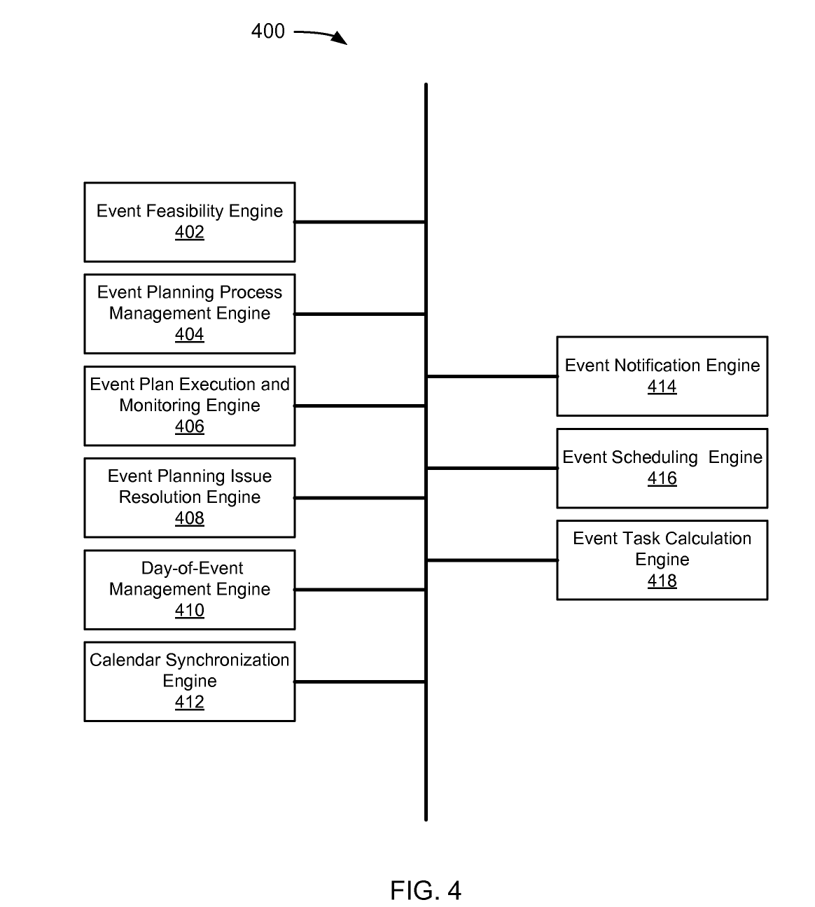

FIG. 4 depicts a diagram 400 of an example of a system for planning a meeting or event. In the example of FIG. 4, the diagram 400 includes an event feasibility engine 402, an event planning process management engine 404, an event plan execution and monitoring engine 406, an event issue resolution engine 408, an day-of-event management engine 410, a calendar synchronization engine 412, a notification engine 414, an event scheduling engine 416, and an event task calculation engine 418. As shown in FIG. 4, the various engines are coupled to each other such that data and information can freely be exchanged between any of the engines. Those skilled in the art will appreciate that for some implementations, the engines shown can be coupled in an alternative arrangement based on a need to exchange data between engines.

In the example of FIG. 4, the event feasibility engine 402 can be configured to enable a planner/job executor to quickly determine what key inputs are needed or requirements to be addressed to determine the meeting or event feasibility. In particular instances, the event feasibility engine 402 can automatically assess business event feasibility based on the event budget and other event requirements (e.g., attendance expectations, venue requirements, staffing requirements, speaker requirements, and participant requirements). Additionally, the event feasibility engine 402 can satisfy multiple outcomes that a planner/job executor needs to accomplish while planning a business-related meeting or event.

In the example of FIG. 4, the event planning process management engine 404 can be configured to use information from multiple inputs (e.g., datastores relating or containing information regarding venues, speaker lists, supplier project management systems, etc.) to implement a project management system for the event planner. The event planning process management engine 404 can be further configured to make decisions regarding the event planning schedule, the event planning requirements, and the scope of work for the event based on input from the information sources and historical event planning data. For various implementations, the event planning process management engine 404 can processes as required and sequences decisions to be made for the event in order to maintain the event planning process in accordance to the event requirements and/or the event budgets. The event planning process management engine 404 can create an event execution plan (also referred to simply as “event plan”), delegate responsibilities (e.g., to other planners/job executors), determine the meeting or event's agenda, and automate decisions about event requirement trade-offs. The event planning process management engine 404 can address multiple outcomes that a customer needs to accomplish while planning a meeting or event.

In the example of FIG. 4, the event plan execution and monitoring engine 406 can be configured to execute on the event execution plan and continuously monitor the progress of the event planning process, and receive dynamic feedback from external inputs to the system to automate event planning. As noted herein, information about the event or meeting can be received from multiple sources, including manual inputs from event planners or vendors (e.g., via a third-party vendor/supplier system). The event plan execution and monitoring engine 406 can facilitate decision-making for event schedules and requirements and can also notify a planner/job executor of any changes needed to the event execution plan. The event plan execution and monitoring engine 406 can be capable of requesting feedback into the system upon achieving certain planning milestones, or automating the process of planning specifics of the event based on predefined criteria (e.g., as securing an event facility, reserving space at local hotels, vetting and requesting bids from suppliers, and managing event attendee needs). For some implementations, the event plan execution and monitoring engine 406 address multiple outcomes that a customer needs to accomplish while planning a business event, including outcomes related to securing the event facility, securing hotel accommodations, securing day-of event staff, securing suppliers, securing speakers and participants, confirming the plan with stakeholders, negotiating supplier agreements, prepaying vendors, and/or pre-registering event attendees.

For example, the event plan execution and monitoring engine 406 can be configured to re-assess venue options and rebook a larger or smaller venue based on the number of pre-registered attendees by a certain date. In another example, the event plan execution and monitoring engine 406 can be configured to automatically close pre-registration for an event when the capacity of the venue has been reached. Information regarding the venue and pre-registration for an event can be provided from various datasources coupled to the system, including an attendee registration datasource and/or a venue datastore.

In the example of FIG. 4, the event issue resolution engine 408 can be configured to enable the planner/job executor to flag and resolve event planning discrepancies, address changes to the execution plan, and makes decisions about discrepancy resolution based on multiple input sources. Depending on the implementation, discrepancies and decisions are either automated or presented to the planner/job executor with the required data to make the decision. Additionally, a recommendation based on the system's event requirement analysis and historical precedent may be presented to the planner/job executor when a discrepancy is presented.

In the example of FIG. 4, the day-of-event management engine 410 can be configured to enable the planner/job executor to manage and optimize event setup requirements and timeline, manage training for day-of-event staff, provide appropriate set-up assistance to suppliers and staff, and check in event attendees.

In the example of FIG. 4, the calendar synchronization engine 412 can be configured to synchronize a user calendar with the platform. In a specific implementation, when a user's calendar is synchronized with the platform, the system can automatically calculate an event schedule, recommend schedules for event resources, and suggest event agendas. The calendar synchronization engine 412 enables the platform to track the planner's schedule and allocate time for certain event planning or event management tasks.

In the example of FIG. 4, the notification engine 414 can be configured to facilitate notification of the planner/job executor by the various engines shown in FIG. 4. For example, the notification engine 414 can notify the planner/job executor of changes in the event execution plan and/or notified of issues with the event execution plan. Additionally, the notification engine 414 can provide end attendee alerts, for example, to alert a of an updated event schedule by SMS. The notification engine 414 can be further utilized to send notification and messages to vendor/suppliers based on certain conditions, schedules, or milestones. For instance, the notification engine 414 can transmit emails to venues and hotels based on pre-registration of attendees. The notification engine 414 can also notify the planner/job executor of discrepancies identified, for example, by the event issue resolution engine 408.

In the example of FIG. 4, the event scheduling engine 416 can be configured to generate various schedules based on inputs received by the system. Schedules generated by the event scheduling engine 416 include, for example, general event schedules (e.g., for attendees), event plan schedule (e.g., for planner/job executors), and delivery schedule for event resources (e.g., for vendors/suppliers of such event resources). For various implementations, the event scheduling engine 416 can update various schedules according to changes detected in the event execution plan, event requirements, event budgets, and status/condition of event resources.

In the example of FIG. 4, the event task calculation engine 418 can be configured to make decisions about what event planning tasks can be carried out based on current information provided to the system. The event tasks can be determined from the current event execution plan and historical maintenance data.

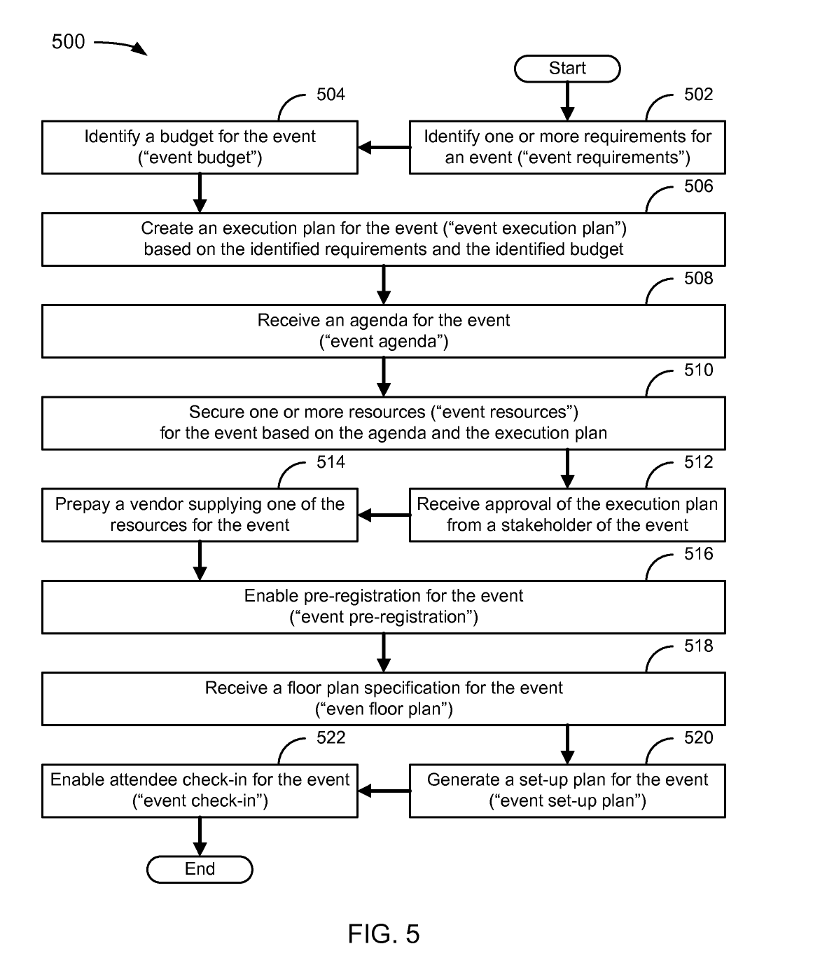

FIG. 5 depicts a flowchart 500 of an example of a method for planning a meeting or event. In the example of FIG. 5, the flowchart 500 starts at module 502 with identifying an event requirement for an event and continues to module 504 with identifying an event budget for the event; module 506 with creating an execution plan for the event based on the identified event requirement and the identified event budget; module 508 with receiving an agenda for the event; module 510 with securing a resource to be used in association with the event based on the agenda, the execution plan, and a condition of the resource; module 512 with receiving approval of the execution plan from a stakeholder of the event; module 514 with prepaying a vendor supplying the resource for the event; module 516 with enabling pre-registration to the event by an attendee of the event; module 518 with receiving a floor plan specification for the event; module 520 with generating a set-up plan for the event based on the floor plan specification; and ends at module 522 with enables attendee check-in for the event. Although not shown, for some implementations, the flowchart 500 can further include a module (e.g., between module 516 and 518) where a planner/job executor is notified of changes in the event execution plan and/or notified of issues with the event execution plan. The changes or issued can be based on information from various datastores (e.g., vendor/supplier system) and monitored by another module (not shown).

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

What is claimed is:

1. A system comprising:
an event planning server configured for operation with one or more clients;
an event resource management engine configured to manage one or more resources to be used in association with an event, to monitor a condition of the resources, and to report information regarding the condition of the resources to the event planning server;
an event parameters datastore;
a event parameter provisioning engine, coupled to the event parameters datastore, for providing event parameters to the event planning server;
wherein, in operation, the event planning server:
identifies an event requirement for the event based at least on data from the event parameter provisioning engine;
identifies an event budget for the event based at least on data from the event parameter provisioning engine;
creates an execution plan for the event based on the identified event requirement and the identified event budget;
receives an agenda for the event through one of the clients;
secures at the least one resource to be used in association with the event based on the agenda, the execution plan, and a condition of the at least one resource;
receives approval of the execution plan from a stakeholder of the event through one of the clients;
prepays a vendor supplying one of the resources for the event;
enables pre-registration to the event by an attendee of the event through one of the clients.

2. The system of claim 1, wherein, in operation, the event planning server further:
receives a floor plan specification for the event;
generates a set-up plan for the event based on the floor plan specification.

3. The system of claim 1, wherein, in operation, the event planning server further:
monitors a condition of one of the resources;
notifies a planner of the event, through one of the clients, of a change to the execution plan based on the condition of the at least one resource.

4. The system of claim 1, wherein, in operation, the event planning server further:
monitors the condition of the at least one resource;
notifies the attendee of the event, through one of the clients, of a change to the agenda based on the condition of the at least one resource.

5. The system of claim 1, wherein, in operation, the event planning server further enables attendee check-in for the event.

6. The system of claim 1, further comprising a protected gateway to secure equipment control systems.

7. The system of claim 1, further comprising an event scheduling engine configured to create a schedule for the event based on the execution plan and the agenda.

8. The system of claim 5, further comprising a time elements engine configured to synchronize the schedule for the event with an event planner's calendar.

9. The system of claim 1, further comprising a location elements engine configured to reconcile a location of the event with an event planner's location.

10. The system of claim 1, further comprising a real-time elements engine configured to enable real-time information delivery from the event resource management engine to the event planning server.

11. The system of claim 1, further comprising a historic and predictive elements engine configured to assist the event planning server in determining a likelihood that the vendor will provide the at least one resource on time.

12. The system of claim 1, further comprising an optimization of parameters engine configured to make decisions regarding delivery of at least one of the resources.

13. The system of claim 1, further comprising an application programming interface (API) for multiple input sources or a third party vendor system.

14. The system of claim 1, further comprising a vendor connectivity engine configured to facilitate a connection between a third-party vendor system and the event resource management engine.

15. The system of claim 1, further comprising feedback engine configured to learn from historical data a planner's preference with respect to the system.

16. The system of claim 1, further comprising continuous calculations and decisions engine configured to enable the event planning server to continuously receive and process information regarding the resources.

17. The system of claim 1, further comprising a self-scaling engine configured to detect available computing resources and scale service to the available computer resources.

18. A method comprising, at an event planning platform:
identifying an event requirement for an event;
identifying an event budget for the event;
creating an execution plan for the event based on the identified event requirement and the identified event budget;
receiving an agenda for the event;
securing a resource to be used in association with the event based on the agenda, the execution plan, and a condition of the resource;
receiving approval of the execution plan from a stakeholder of the event;
prepaying a vendor supplying the resource for the event;
enabling pre-registration to the event by an attendee of the event.

19. A system comprising:
a means for identifying an event requirement for an event;
a means for identifying an event budget for the event;
a means for creating an execution plan for the event based on the identified event requirement and the identified event budget;
a means for receiving an agenda for the event;
a means for securing a resource to be used in association with the event based on the agenda, the execution plan, and a condition of the resource;
a means for receiving approval of the execution plan from a stakeholder of the event;
a means for prepaying a vendor supplying the resource for the event;
a means for enabling pre-registration to the event by an attendee of the event.
